(19) United States
(12) Patent Application Publication
(10) Pub. No.: US 2005/0039634 A1
(43) Pub. Date: Feb. 24, 2005

(54) Non-aqueous ink jet inks with improved decap

(76) Inventor: Clarence Gaetano Hermansky, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/886,347

(22) Filed: Jul. 7, 2004

Related U.S. Application Data
(60) Provisional application No. 60/486,723, filed on Jul. 11, 2003.

(51) Int. Cl. C09D 11/02; B41J 2/01

(52) U.S. Cl. 106/31.59; 106/31.89; 106/31.58; 106/31.86; 347/100

(57) ABSTRACT

This invention pertains to a non-aqueous inkjet ink including a non-ionic surfactant for improved decap.

### CROSS-REFERENCE TO RELATED APPLICATIONS

This application claims priority under 35 U.S.C. §119 from U.S. Provisional Application Ser. No. 60/486,723 (filed Jul. 11, 2003), the disclosure of which is incorporated by reference herein for all purposes as if fully set forth.

### BACKGROUND OF THE INVENTION

This invention pertains to a non-aqueous inkjet ink, in particular to a non-aqueous inkjet ink with a surfactant for improved decap. Inkjet printing is a non-impact printing process in which droplets of ink are deposited on print media, such as paper, to form the desired image. The droplets are ejected from a printhead in response to electrical signals generated by a microprocessor. Inkjet printers offer low-cost, high quality printing. As such, inkjet printers have become a popular alternative to other types of printers, such as the more expensive laser printers.

An important attribute of inkjet ink is “decap” time, that is, the time a nozzle can remain dormant and then still fire a drop without loss of velocity or misdirection. Decap is at least in significant part caused by ink vehicle evaporation which leaves behind a deposit of nonvolatile ingredients that are detrimental to jetting performance.

Aqueous inkjet inks which comprise water as the predominate component of the ink vehicle tend to dry out quickly on an inkjet nozzle and thus have a short decap time. Humectants are added to aqueous ink formulations to retard drying and, although these ingredient can improve decap somewhat, decap is still undesirably short. Addition of very high levels of humectant tends to make the ink too viscous for most inkjet applications.

Non-aqueous inkjet inks suffer similar problems. Vehicle solvents with low viscosity tend to evaporate quickly and solvents with low volatility tend to be too viscous.

A need still exists for inkjet inks with longer decap times.

### SUMMARY OF THE INVENTION

This invention pertains to a non-aqueous inkjet ink with improved decap time which, as discussed above, is the amount of time a nozzle can remain dormant and then be fired again without any detrimental effect on the droplet velocity, weight or direction. A longer decap time is preferred because it allows greater productivity by reducing the need for “servicing” the printhead.

Decap is related, in part at least, to the volatility of the vehicle components. The non-volatile ink components dissolved or dispersed in the vehicle, especially the colorant, come out of solution or suspension and deposit on the nozzle orifice as the vehicle evaporates.

It is useful then for the vehicle to have a slow(er) evaporation rate. However, the nature of the ink residue upon partial evaporation of the vehicle is also important. If an ink can retain a fluid consistency even after a substantial amount of vehicle evaporates, it is more likely to have longer decap time.

The present invention addresses the decap problem by providing a non-aqueous inkjet ink comprising a colorant, a non-aqueous vehicle and an effective amount of a non-ionic surfactant.

An “effective amount” of surfactant means a sufficient amount to achieve an increase in decap time as compared to the same ink without the surfactant. Preferably the increase in decap time is at least twenty seconds, more preferable at least 30 seconds. A test for measuring decap is provide in the Examples below. An effective amount of surfactant is typically in the range of about 2 to about 20% by weight, and more typically in the range of about 3 to about 10% by weight, based on the total weight of the ink.

Preferably the surfactants comprise polyether and/or polyhydroxyl polar group(s), and have an HLB less than about 27, preferably less than about 21, and more preferably less than about 15.

The range of non-aqueous solvents available allows control over the vehicle evaporate rate, and it is believed that the presence of appropriate levels of surfactant advantageously affects the nature of the ink deposit on dry down. The preceding discussion is speculative only and in no way limits the scope of the invention to any particular mechanism of operation.

In accordance with another aspect of the present invention, there is provided an ink set comprising at least three differently colored inks, wherein at least one of the inks is a non-aqueous inkjet ink as set forth above.

In yet another aspect of the present invention, there is provided a method for ink-jet printing onto a substrate, comprising the steps of:
(a) providing an ink jet printer that is responsive to digital data signals;
(b) loading the printer with a substrate to be printed;
(c) loading the printer with a non-aqueous ink as set forth above and described in further detail below, or an ink jet ink set as set forth above and described in further detail below; and
(d) printing onto the substrate using the ink or inkjet ink set in response to the digital data signals.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise.

### DETAILED DESCRIPTION OF THE PREFERRED EMBODIMENTS

Colorant

The colorant can be soluble (dye) or dispersed (pigment) in the non-aqueous ink vehicle, including mixtures of the two types.

Suitable dyes for inkjet applications are generally well known. A representative selection of such dyes can be found, for example, in U.S. Pat. No. 5,932,631, U.S. Pat. No. 6,342,094 and US SIR H1967, the disclosures of which are incorporated by reference herein for all purposes as if fully set forth. The exact choice of dyes will depend upon the color reproduction and print quality requirements of the application.

Useful dyes include, for example, yellow dyes such as C.I. Solvent Yellow 19, C.I. Solvent Yellow 21, C.I. Solvent Yellow 61, C.I. Solvent Yellow 80; orange dyes such as C.I. Solvent Orange 1, C.I. Orange 37, C.I. Orange 40; red dyes such as C.I. Solvent Red 8, C.I. Solvent Red 81, C.I. Solvent Red 82, C.I. Solvent Red 84, C.I. Solvent Red 100, Acid Red 92, Reactive red 31; violet dyes such as C.I. Solvent Violet 8, C.I. Solvent Violet 21; blue dyes such as C.I. Solvent Blue 2, C.I. Solvent Blue 11, C.I. Solvent Blue 25, C.I. Solvent Blue 36, C.I. Solvent Blue 55; green dyes such as C.I. Solvent Green 3; black dyes such as C.I. Solvent Black 3, C.I. Solvent Black 5, C.I. Solvent Black 7, C.I. Solvent Black 22, C.I. Solvent Black 27, C.I. Solvent Black 29, Acid Black 123.

The levels of dye employed in the instant inks of this invention are those levels that are typically needed to impart the desired optical density to the printed image. Typically, dye levels are in the range of about 0.01 to about 20% by weight, more preferably about 2 to about 12% by weight, based on the total weight of the ink.

Suitable pigments for inkjet applications are also generally well known. A representative selection of such pigments are found, for example, in U.S. Pat. No. 6,258,155, U.S. Pat. No. 5,026,427, U.S. Pat. No. 5,086,698, U.S. Pat. No. 5,141,556, U.S. Pat. No. 6,160,370 and U.S. Pat. No. 5,169,436, the disclosures of which are incorporated by reference herein for all purposes as if fully set forth. The exact choice of pigment will depend upon color reproduction and print quality requirements of the application. The pigment may be black, such as those based on carbon black, or may be colored such as those based on cyan (e.g. PB 15:3 and 15:4), magenta (e.g. PR 122 and 123), and yellow (e.g. PY 74, 120, 128 and 139).

Pigments, traditionally, are stabilized to dispersion by dispersing agents, especially polymeric dispersants. More recently though, so-called “self-dispersible” or “self-dispersing” pigments (hereafter “SDP”) have been developed. As the name would imply, SDPs are dispersible in a vehicle without dispersants.

Dispersants to stabilize the pigments to dispersion are preferably polymeric because of their efficiency. Examples of typical dispersants for nonaqueous pigment dispersions include, but are not limited to, those sold under the trade names: Disperbyk (BYK-Chemi, USA), Solsperse (Avecia) and EFKA (EFKA Chemicals) polymeric dispersants.

As indicated above, suitable pigments also comprise self-dispersing pigment. SDPs for aqueous inks are well known. SDPs for non-aqueous ink are also known and include, for example, those described in U.S. Pat. No. 6,476,096, US2001/003263A1 and US2002/0056403A1, the disclosures of which are incorporated by reference herein for all purposes as if fully set forth.

It is desirable to use small pigment particles for maximum color strength and good jetting. The particle size may generally be in the range of from about 0.005 micron to about 15 microns, is typically in the range of from about 0.005 to about 1 micron, is preferably from about 0.005 to about 0.5 micron, and is more preferably in the range of from about 0.01 to about 0.3 micron.

The levels of pigment employed in the instant inks of this invention are those levels that are typically needed to impart the desired optical density to the printed image. Typically, pigment levels are in the range of about 0.01 to about 10% by weight, more preferably about 2 to about 8% by weight, based on the total weight of the ink.

When dispersants are used, they are typically present at pigment to dispersant weight ratios ranging from about 2:1 to about 1:2.

Non-Aqueous Vehicle

“Non-aqueous vehicle” refers a liquid that is substantially comprised of non-aqueous solvent, or mixtures of solvents, where the solvent can be polar or nonpolar. Solvents suitable for use in the inks of the present invention include alcohols, esters, ketones, ethers, and aliphatic and aromatic hydrocarbons.

The relative evaporation rate (ER) of solvents is determined relative to a standard, n-butyl acetate, which is assigned value 1.0. Solvents that evaporate slower than this standard receive an ER less than 1.0. For example, dipropylene glycol butyl ether (e.g. Dowanol DPnB) has an ER of 0.004. Preferred solvents have a value of ER between about 0.004 and about 1.0, with solvents having higher values of ER being useful especially when combined in a vehicle with solvents of lower ER. Sources of information on evaporation rate data and testing include Arco, Dow, Dupont, Eastman and Exxon product literature, and ASTM test method D3539.

Preferred solvents include, but are not limited to, mono- and di-alkyl ethers of glycols and polyglycols such as monomethyl ethers of mono-, di- and tri-propylene glycols and the mono-n-butyl ethers of ethylene, diethylene and triethylene glycols, aliphatic and aromatic hydrocarbons having at least six carbon atoms and mixtures thereof including refinery distillation products and by-products, and alkyl acetate esters and combinations thereof.

Even when no water is deliberately added to the non-aqueous vehicle, some adventitious water may be carried into the formulation, but generally this will be no more than about 2-4% by weight, based on the total weight of the ink. By definition, the non-aqueous inks of this invention will have no more than about 5% by weight water, and preferably no more than about 3% by weight water, based on the total weight of the ink.

The amount of non-aqueous vehicle in the ink is typically in the range of about 70% to about 99% by weight, and preferably about 80% to about 99% by weight, based on total weight of the ink.

Surfactant

“Surfactant” is an abbreviation for surface-active agent, a material that tends to absorb at surfaces and interfaces. Surfactant molecules typically consist of at least one “non-polar” portion and at least one “polar” portion. The non-polar hydrocarbon portion is usually oil or solvent-soluble (lyophilic) and may comprise linear or branched alkyl, aryl or alkylaryl chains. The non-polar portion of the surfactant is preferably comprised of substantially no polydimethylsiloxane groups or fluorination; in other words, the surfactant is other than what are commonly referred to as “silicone” and “fluoro” surfactants. The polar portion of a surfactant can, in general, be ionic or non-ionic but is restricted for the purpose of this invention to polar non-ionic groups, preferably polyether and/or polyhydroxyl polar group(s), more preferably (poly)alkylene oxide groups, and especially (poly)ethylene oxide groups. The size and relative proportions of the polar and non-polar groups determine the properties of the surfactant.

One measure of relative proportion of polar and non-polar portions of a surfactant is given by a quantity called the hydrophile-lipophile balance (HLB). The HLB is an empirical value on a relative scale where surfactants with high non-polar content have low HLB numbers and surfactants with high polar content have high HLB numbers. The determination of HLB is calculated by various techniques and is available from many sources, including surfactant supplier product literature and standard surfactant texts. For the purpose of this invention, the HLB can be calculated using the (E+P)/5 relationship described in “Nonionic Surfactants”, M. Schick, Marcel Dekker, New York, 1966 (the relevant disclosure of which is incorporated by reference herein for all purposes as if fully set forth). In this equation, E and P are the weight percent oxyethylene and polyol, respectively.

Useful non-ionic surfactants are exemplified by the following classes of materials: polyoxyethylene alkylphenols, polyoxyethylene alcohols; polyoxyethylene esters of fatty acids; polyols; polyalkylene oxide block copolymer. The HLB is preferably less than about 27, more preferably less than about 21, and still more preferably less than about 15.

The amount of surfactant in the ink of this invention should be an effective amount as defined previously. Preferably the amount is about 2 to about 20%, preferably about 3 to about 10%, by weight based on total weight of ink.

Other Ingredients

Other ingredients may be formulated into the ink of this invention, to the extent that they do not interfere with the jettablity, viscosity and other desirable properties of the ink. Such other ingredients are generally well known in the art and include one or more of: an antifoaming agent, light stabilizer, viscosity modifier, and the like, to improve various properties or function of the ink composition as needed.

The amount of each ingredient must be properly determined, but is typically in the range of about 0.1 to about 15% by weight, and more typically about 0.2 to about 10% by weight, based on the total weight of the ink.

Binder may be also used and can be soluble or dispersed polymer(s) added to the ink to improve the adhesion of a pigment. Nonlimiting examples of polymers that can be used include polyesters, polystyrene/acrylates, sulfonated polyesters, polyurethanes, polyimides and the like. When present, soluble polymer is advantageously used at levels of at least about 0.3%, and preferably at least about 0.6%, based on the final weight of ink. Ink viscosity or other well-known physical limitations dictate upper limits.

Ink Properties

Jet velocity, drop size and stability are greatly affected by the surface tension and the viscosity of the ink. Inkjet inks typically have a surface tension in the range of about 20 dyne/cm to about 60 dyne/cm at 25° C. Viscosity can be as high as about 30 cP at 25° C., but is typically somewhat lower. The ink has physical properties compatible with a wide range of ejecting conditions, e.g., the driving frequency of the piezo element, or ejection conditions for a thermal head, or the shape and size of the nozzle. The ink of this invention should have excellent storage stability for long periods so as not clog to a significant extent in an inkjet apparatus. Further, it should not alter the materials of construction of the inkjet printing device it comes in contact with, and be essentially odorless and non-toxic.

Although not restricted to any particular viscosity range or printhead, the inventive ink is particularly suited to lower viscosity applications such as those required by printheads that jet small droplet volumes, e.g. less than 10 pL. Thus the viscosity (at 25° C.) of the inventive ink can be less than about 7 cPs, preferably less than about 5 cPs, and most advantageously less than about 3.5 cPs.

Substrate

The instant invention is particularly advantageous for printing on plain paper such as common electrophotographic copier paper.

### EXAMPLES

Some of the ingredients referred to in these examples by tradename are as follows:

| Tradename | Chemical identity | Source |
|---|---|---|
| Brij ® 30 | Polyoxyethylene (4) lauryl ether | Aldrich |
| Brij ® 72 | Polyoxyethylene (2) stearyl ether | Aldrich |
| Brij ® 92 | Polyoxyethylene (2) oleyl ether | Aldrich |
| Brij ® 97 | Polyoxyethylene (10) oleyl ether | Aldrich |
| Dowfax ® 8390 | Sodium n-hexadecyl diphenyloxide disulfonate | Dow Corn. |
| Dynol ® 604 | Acetylenic glycol | Air Prod. |
| Pluronic ® 10R5 | Polyoxypropylated Polyethylene Glycol | BASF |
| Pluronic ® 17-R-4 | Polyoxypropylated Polyethylene Glycol | BASF |
| Pluronic ® F108 | Polyoxyethylated Polypropylene Glycol | BASF |
| Pluronic ® L31 | Polyoxyethylated Polypropylene Glycol | BASF |
| Pluronic ® L62 | Polyoxyethylated Polypropylene Glycol | BASF |
| Pluronic ® L64 | Polyoxyethylated Polypropylene Glycol | BASF |
| Silwet ® L7700 | Polyalkyleneoxide modified heptamethyltrisiloxane | Aldrich |
| Sodium Lauryl Sulfate | Sodium Lauryl Sulfate | Aldrich |
| Span ® 60 | Sorbitan stearate | Aldrich |
| Surfynol ® 465 | Tetramethyl decynediol (10) ethoxylate | Air Prod. |
| Surfynol ® 485 | Tetramethyl decynediol (30) ethoxylate | Air Prod. |
| Tergitol ® NP4 | Phenoxyethylene (4) Nonylphenol | Dow Chem. |
| Tergitol ® NP9 | Phenoxyethylene (9) Nonylphenol | Dow Chem. |
| Tetronic ® 304 | polyalkoxylated copolymers of ethylene diamine | BASF |
| Tween ® 60 | Polysorbate 60 | ICI Americas |
| | | Inc. |
| Zonyl ® FSX | Fluoronated surfactant | Dupont |

Preparation of Pigment Dispersions

Slurries of Dispersions A and B were prepared according to the recipe in the following table, and thereafter milled in a media mill with 0.6-0.8 mm zirconia media. Disperbyk® 2000 and Disperbyk® 161 are dispersants available from Byk Chemie.

| Ingredients | Dispersion A | Dispersion B |
|---|---|---|
| Pigment PY139 (as wt % pigment) | 22.2 g | — |
| Pigment PY120 (as wt % pigment) | — | 22.2 g |
| Disperbyk ® 2000 (as wt % solids)^{a} | 11.1 g | — |
| Disperbyk ® 161 (as wt % solids)^{b} | — | 11.1 g |
| Dowanol DPM | 66.7 g | — |
| Dowanol DPnB | — | 66.7 g |
| Measured Viscosity (cps @ 25° C.) | 45 | 35 |
| Median Part. Size (nm) | 78 | 219 |

^{a}40 wt % solids in 1/1 methoxypropylacetate/butylglycol solvent blend.
^{b}30 wt % solids in 6/1 methoxypropylacetate/butylglycol solvent blend.

After milling to the desired endpoint, the media was separated and solvent added to adjust the final pigment concentration to 20.0% by weight. Viscosity was measured using a Brookfield viscometer, at 25° C., equipped with an ultra-low viscosity adapter (ULA). Particle size was measured using a Microtrac UPA150.

### Example 1

Ink formulations prepared from Dispersions A and B are given in the following table. Each ink was prepared by adding the indicated additives followed by dilution with solvent to effect a pigment concentration of 4.9 percent by weight based on total ink weight.

| | Ink Formulatons (wt %) | | | |
|---|---|---|---|---|
| Ingredients | Ink 1A* | Ink 11 | Ink 12 | Ink 1B* |
| Dispersion A (as wt % pigment) | 4.9 | 4.9 | 4.9 | |
| Dispersion B (as wt % pigment) | | | | 4.88 |
| Brij ® 30 | | 9.3 | | |
| Brij ® 92 | | | 9.3 | |
| Dowanol DPM | 75.6 | 66.3 | 66.3 | |
| Dowanol DPnB | | | | 75.6 |
| Decap Time (sec) | 5 | 50 | 90 | >100 |

*Control sample

All inks were filtered through a 2.0 micron filter prior to testing. Decap time was measured using the black print-head of an Epson 850 printer equipped with software to operate the pen in a non-serviced mode—that is not capped, wiped or fired at the service station during the test. Decap time was assessed by the presence or absence of a vertical series of adjacent lines printed on plain paper, after remaining dormant for various lengths of time (seconds). The time at which a given ink showed a marked decrease or absence of vertical line print, upon resumption of printing, was taken as a measure of the decap time. Ink 1A and 1B are control inks having solvents with relative evaporation rates of 0.02 (Dowanol DPM) and 0.004 (Dowanol DPnB), respectively. Decap times for Inks 11 and 12 show the improvement to the decap time of the more volatile Control Ink 1A with addition of non-ionic surfactant.

### Example 2

The consistency of an ink at the pen/nozzle-air interface, e.g. its tendency to remain fluid on prolonged exposure to air, was tested for by placing small droplets (˜1 μL) of ink on polyethylene imine (nozzle plate material) sheet and observing their consistency over time, at about 35° C. The ink compositions tested and the observations made are given in the following table. The consistency of each droplet was evaluated using the following scale: “D”—completely dried; “S”—semi-solid, thick but not completely dry; “L”—liquid similar to the initial consistency of the ink; and “vL” viscous liquid but not semi-solid.

| | Ink Samples (weight, grams) | | | | | | | |
|---|---|---|---|---|---|---|---|---|
| Ingredients | 2A* | 21 | 22 | 23 | 2B* | 25 | 26 | 27 |
| Dispersion A | 5.0 | 5.0 | 5.0 | 5.0 | | | | |
| Dispersion B | | | | | 5.0 | 5.0 | 5.0 | 5.0 |
| Brij ® 97 | | 1.9 | | | | 1.9 | | |
| Brij ® 30 | | | 1.9 | | | | 1.9 | |
| Brij ® 92 | | | | 1.9 | | | | 1.9 |
| Dowanol DPM | 15.5 | 13.6 | 13.6 | 13.6 | | | | |
| Dowanol DPnB | | | | | 15.5 | 13.6 | 13.6 | 13.6 |
| Evaluation | | | | | | | | |
| 30 minutes | D | L | L | L | L | L | L | L |
| 60 minutes | — | L | L | L | L | L | L | L |
| 120 minutes | — | L | L | L | L | L | L | L |
| Evaluation | (5% Surfactant)^{a} | | | | | | | |
| 45 minutes | — | L | L | L | L | L | L | L |
| 90 minutes | — | L | L | L | L | L | L | L |
| 210 minutes | — | S | S | S | D | S | S | S |

*Control samples
^{a}Initial surfactant level was halved, to 5%, and the balance made up with solvent.

The results for control inks 2A and 2B were consistent with the decap test results of Example 1. Ink 2A rapidly dried to a solid deposit (ER=0.02, Dowanol DPM solvent) while Ink 2B remained a liquid (ER=0.004, Dowanol DPnB) except at the lower surfactant content (5%) and longest time (210 minutes).

Inks 21 through 27 demonstrate the beneficial affect of the surfactant at 5 and 10 percent by weight, extending the liquid consistency of the ink to longer times. This would allow for improved jettability over extended exposure to air and make the nozzle openings easier to clear should a plug begin to form.

Further testing of the non-ionic surfactants of Example 2 showed that the change in consistency, from a dry deposit to a liquid-like residue, occurs over a range (e.g. 2-5% by weight) of non-ionic surfactant levels, depending on the surfactant. In each case, the level needed would be readily determined by one skilled in the art.

Evaporation rate measurements were also made on selected inks, to determine if the additives of this invention affect the bulk evaporation rate of the ink. Evaporative mass loss was measured over time at 27° C. on equal areas of ink-air interface. The results indicate surfactant additives contemplated by the present invention do not reduce the bulk evaporation rate of the vehicle. Thus, increased decap is obtained without sacrificing dry time.

### Example 3

Using the method described in Example 2, a range of other ingredients were evaluated, including non-surface active (short chain) alcohols, diols and glycols, and ionic surfactants. The sample inks contained two grams of Dispersion A, 5.5 grams of Dowanol DPM and 0.75 grams (12 percent by weight, unless otherwise indicated) of each of the test ingredient. Small droplets (˜1 □L) of each ink were placed on a small strip of polyethylene imine and the consistency evaluated, over time, at 25° C. and 35° C. Consistency evaluations are summarized in the following table. Each ink is identified by the test ingredient.

| | 2 hrs. | 4 hrs. | 5 hrs. | 18 hrs. |
|---|---|---|---|---|
| Test Ingredient | @35° C. | @35° C. | @25° C. | @25° C. |
| Alcohol Solvents | | | | |
| (Comp.) | | | | |
| Cyclohexanol | D | D | D | D |
| Propylene glycol | D | D | D | D |
| n-Octanol | D | D | S | D |
| Isopropanol | D | D | S | D |
| Benzyl alcohol | S | D | S | D |
| LEG-1 | D | S | S | S |
| Glycerine | D | S | S | S |
| 1,3-Propane diol | S | S | S | S |
| 1,4-Butylene glycol | S | S | S | S |
| Diethylene glycol | S | S | vL | S |
| Polyethylene Glycol | — | — | D | D |
| MW = 200 | | | | |
| Surfactants (Comp.) | | | | |
| Silwet ® L7700 | — | — | D | D |
| Zonyl ® FSX | — | — | D | D |
| Dowfax ® 8390 | D | D | D | D |
| Surfactants (Inv.) | | | | |
| Tween ® 60 | S | S | S | S |
| Brij ® 72 | S | S | L | L |
| Pluronic ® L64 | S | L | S | S |
| Span ® 60 | S | D | L | L |
| Pluronic ® L62 | S | L | vL | vL |
| Dynol ® 604 | L | vL | vL | S |
| Pluronic ® L31 | L | L | L | vL |
| Brij ® 30 | L | L | vL | vL |

In general, alcohols, glycols or diols, and polyethylene glycol, materials that are not surfactants, dry or become semi-solid residues. Likewise, Dowfax® 8390 anionic surfactant, Silwet®) silicone surfactant and Zonyl® fluorosurfactant also formed dry residues on exposure to air. In contrast, ethoxylated non-ionic surfactants, such as those contemplated by this invention, produced a more fluid residue on exposure to air.

### Example 4

A selection of non-ionic surfactants, covering a wide range of HLB, and two anionic surfactant controls were also tested, as in Example 3. The level of each surfactant was 10 percent, by weight. The test was performed at 25° C. 2 hrs. 4 hrs.

| | | 2 hrs. | 4 hrs. |
|---|---|---|---|
| Test Ingredient | HLB | @25° C. | @25° C. |
| Pluronic ® L31 | 3.5 | L | L |
| Span ® 60 | 4.7 | L | L |
| Brij ® 72 | 4.9 | L | L |
| Pluronic ® L62 | 7.0 | vL | vL |
| Tergitol ® NP4 | 8.9 | L | vL |
| Brij ® 30 | 9.7 | L | vL |
| Tergitol ® NP9 | 12.9 | L | L |
| Surfynol ® 465 | 13.0 | L | L |
| Tween ® 60 | 14.9 | L | S |
| Pluronic ® L64 | 15.0 | L | S |
| Tetronic ® 304 | 16.0 | L | S |
| Pluronic ® 17-R-4 | 16.0 | L | S |
| Surfynol ® 485 | 17.0 | L | vL |
| Pluronic ® 10RF | 21.0 | vL | S |
| Pluronic ® F108 | 27.0 | D | D |
| Comparative | | | |
| Sodium Lauryl Sulfate (Anonic) | ˜40 | D | D |
| Dowfax 8390 (Anonic) | High | D | D |

In general, the nonionic surfactants with higher HLB were more likely to form deposits with an undesirable consistency, i.e. semi-solid or completely dried.

### Example 5

This example demonstrates the invention with a soluble colorant, Solvent Red 122 dye. Ink formulations were prepared according to the recipes in the following table. As before, small droplets (˜1 μL) of each ink were placed on a small strip of polyethylene imine and the consistency evaluated over time, at 25° C. using the previously described scale.

| | Ink Formulations (weight percent) | | | | |
|---|---|---|---|---|---|
| Ingredients | Ink 5A* | Ink 51 | Ink 52 | Ink 53 | Ink 54 |
| Solvent Red 122 | 2.0 | 2.0 | 2.0 | 2.0 | 2.0 |
| Brij ® 30 | | 10 | 5 | | |
| Pluronic ® L31 | | | | 10 | 5 |
| Dowanol PMA | 98 | 88 | 93 | 88 | 93 |
| Evaluation | | | | | |
| 2 hrs. | D | L | L | L | L |
| 4 hrs. | D | L | L | L | vL |

*Control sample

The results are consistent with those found with dispersed colorant, that is the addition of a nonionic surfactant delays or eliminates the formation of a dry or semi-solid deposit.

1. A non-aqueous inkjet ink comprising a colorant, a non-aqueous vehicle and an effective amount of a non-ionic surfactant.

2. The non-aqueous inkjet ink of claim 1, wherein the non-ionic surfactant comprises a non-polar portion and a polar portion, wherein the polar portion is non-ionic.

3. The non-aqueous inkjet ink of claim 2, wherein the polar portion of the non-ionic surfactant comprises polyether and/or polyhydroxyl polar group(s).

4. The non-aqueous inkjet ink of claim 2, wherein the polar portion of the non-ionic surfactant comprises polyethylene oxide polar group(s).

5. The non-aqueous inkjet ink of claim 2, wherein the non-polar portion of the surfactant comprises substantially no polydimethylsiloxane groups or fluorination.

6. The non-aqueous inkjet ink of claim 1, wherein the non-ionic surfactant has an HLB of less than about 27.

7. The non-aqueous inkjet ink of claim 1, wherein the non-ionic surfactant has an HLB of less than about 21.

8. The non-aqueous inkjet ink of claim 1, wherein the surfactant is present in an amount effective to increase decap by at least 20 seconds.

9. The non-aqueous inkjet ink of claim 1, wherein the surfactant is present in an amount of from about 2 to about 20% by weight based on the total weight of ink.

10. The non-aqueous inkjet ink of claim 1, having a surface tension in the range of about 20 dyne/cm to about 60 dyne/cm at 25° C., and a viscosity of lower than about 30 cP at 25° C.

11. The non-aqueous inkjet ink of claim 1, wherein the colorant is a pigment.

12. The non-aqueous inkjet ink of claim 1, wherein the colorant is a dye.

13. An ink set comprising at least three differently colored inks, wherein at least one of the inks is a non-aqueous inkjet ink comprising a colorant, a non-aqueous vehicle and an effective amount of a non-ionic surfactant.

14. The ink set of claim 13, wherein the non-ionic surfactant comprises a non-polar portion and a polar portion, wherein the polar portion is non-ionic.

15. The ink set of claim 14, wherein the polar portion of the non-ionic surfactant comprises polyether and/or polyhydroxyl polar group(s).

16. The ink set of claim 14, wherein the polar portion of the non-ionic surfactant comprises polyethylene oxide polar group(s).

17. The ink set of claim 14, wherein the non-polar portion of the surfactant comprises substantially no polydimethylsiloxane groups or fluorination.

18. The ink set of claim 13, wherein the non-ionic surfactant has an HLB of less than about 27.

19. The ink set of claim 13, wherein the surfactant is present in an amount of from about 2 to about 20% by weight based on the total weight of ink.

20. The ink set of claim 13, wherein the non-aqueous inkjet ink has a surface tension in the range of about 20 dyne/cm to about 60 dyne/cm at 25° C., and a viscosity of lower than about 30 cP at 25° C.

21. The ink set of claim 13, wherein the colorant is a pigment.

22. The ink set of claim 13, wherein the colorant is a dye.

23. A method for ink jet printing onto a substrate, comprising the steps of:
(a) providing an ink jet printer that is responsive to digital data signals;
(b) loading the printer with a substrate to be printed;
(c) loading the printer with a non-aqueous inkjet ink comprising a colorant, a non-aqueous vehicle and an effective amount of a non-ionic surfactant, or an ink set comprising at least three differently colored inks, wherein at least one of the inks is the non-aqueous inkjet ink; and
(d) printing onto the substrate using the ink or inkjet ink set in response to the digital data signals.
